(19) United States
(12) Patent Application Publication
(10) Pub. No.: US 2005/0251621 A1
(43) Pub. Date: Nov. 10, 2005

(54) Method for realizing autonomous load/store by using symbolic machine code

(76) Inventor: Jean-Paul Theis, Hamburg (DE)

Correspondence Address: Ante Vistor Gmbh;Harburger Schlossgtrasse 6-12, 21079 Hamburg, Germany, 21079, DE

(21) Appl. No.: 10/517,198

(22) PCT Filed: May 3, 2002
(86) PCT No.: PCT/EP02/04927

§ 371 Date: Dec. 8, 2004

(51) Int. Cl. G06F 12/00

(52) U.S. Cl. 711/118

(57) ABSTRACT

The invention describes a method for realizing autonomous load/store by using symbolic machine code. Instructions in symbolic machine code may have operands and/or results specifying symbolic variables. Symbolic variables naturally arise as the machine code pendant of pointer variables declared in a program written in some high level programming language. Formally, a symbolic variable specifies an entry in a dedicated memory other than a register file of said microprocessor. Said entry is used by the microprocessor in order to determine the definition address of said variable. By analyzing the symbolic variables specified as instruction operands and results and by writing the definition addresses of said symbolic variables into a heap address cache, the microprocessor dynamically determines the lifetimes of the values of said variables and, based on the lifetimes, determines where in the memory hierarchy said values will be stored.

### 1. FIELD OF THE INVENTION

The present invention relates to the interdisciplinary field of computer hardware and software, in particular to the interactions of compiler design with microprocessor design. More specifically, the invention describes a method which uses symbolic machine code generated by some compiler in order to implement autonomous load/store of data within microprocessors.

### 2. CONVENTIONS, DEFINITION OF TERMS, TERMINOLOGY

If not explicitly mentioned otherwise, the terms defined in this section are identical to those found in the literature. A good reference book on the subject is f. ex. ‘Computer Architecture : A Quantitative Approach, J. Hennessy and D. Patterson, Morgan Kaufmann Publishers, 1996’. However, in order to ease the terminology, in the context of the present invention the term ‘microprocessor’ has a broader meaning than usually found in the literature and may stand for any data processing system in general, and in particular for central processing units (CPU), digital signal processors (DSP), any special-purpose (graphics) processor or any application specific instruction set processor (ASIP), whether embedded, whether being part of a chip-multi-processor system (CMP) or whether stand-alone.

One of the main characteristics of a microprocessor is the fact that it has an instruction set. In other words, some machine code which is running or executed on said microprocessor, contains instructions belonging to said instruction set. Said machine code is usually obtained either by compiling a source code, e.g. a program written some high level programming language like C++, or by manual writing. Each instruction of a said instruction set has an instruction format. Furthermore, said microprocessor may have several different instruction formats such that instructions of a machine code may have different instruction formats. When said machine is running or executed on said microprocessor, this means that instructions contained in said machine code are executed on said microprocessor.

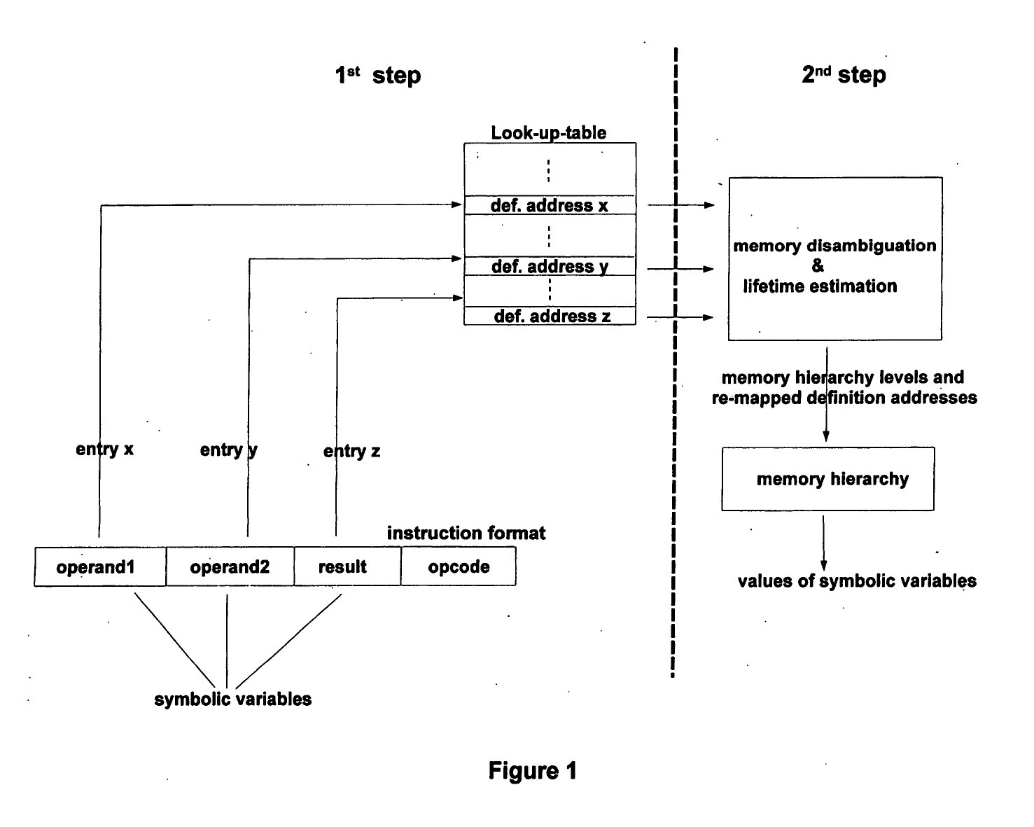

As usual, the term ‘instruction format’ refers to a sequence of bit-fields of a certain length. Said bit-fields may be of different length. An instruction format usually contains a so called ‘opcode’ bit-field and one or more ‘operand’ bit-fields. FIG. 1 illustrates the discussed concepts. The ‘opcode’ bit-field encodes (defines) a specific instruction among all the instructions of an instruction set, e.g. the addition of two numbers or the loading of data from memory or a cache. In the following, instructions which are specified by an ‘opcode’ bit-field are also called ‘explicit’ instructions, this in order to stress the difference with ‘implicit’ instructions which will be defined further below. The ‘operand’ bit-fields specify (encode) the operands of the instruction. In other words, an instruction is a data operation which is specified by (encoded in) the ‘opcode’ bit-field and where the data (or operands) used by said operation are specified by (encoded in) the ‘operand’ bit-fields. Usually, the operands often specify (or are often given in form of) memory references, memory locations (addresses) or registers and the values of the instruction operands are stored to or loaded from said memory addresses or registers. Said memory references and memory locations refer to addresses within the memory system coupled to said microprocessor. As will be discussed in more detail below, said memory system usually has an a memory hierarchy comprising memories at different hierarchy levels such as register files of the microprocessor, L1 and L2 data caches and main memory. In case that instruction operands and/or results specify registers within a register file of said microprocessor, these registers are specified by (or encoded in) said ‘operand’ bit-fields. E.g. in case of a microprocessor with a register file containing 128 registers, an ‘operand’ bit-field of at least 7 bits is required to uniquely specify (or encode) a register inside the register file.

In so-called 3address machines, the instruction format contains also a ‘destination’ bit-field in addition to the ‘operand’ bit-fields, which specifies where the result of said instruction (or data operation) has to be stored. E.g. the result of an arithmetic instruction like an addition of two numbers is equal to the sum of said numbers. The result (or the outcome) of ‘compare’-instructions comparing two numbers x and y, e.g. instructions like ‘x equal-to y’, ‘y smaller-than y’, ‘x greater-than y’ etc. . . . , is equal to a boolean value of either ‘0’ or ‘1’ depending on whether the comparison is true or false. In case of so-called 2-address machines, one of said ‘operand’ bit-fields is at the same time ‘destination’ bit-field such that the operand specified by said ‘operand’ bit-field is at the same time ‘destination’ of said instruction. As for operands, destinations are usually given in form of memory references, memory locations (addresses) or in form of registers and the values of the instruction results are stored to or loaded from said memory addresses or registers. Furthermore, ‘compare’-instructions often write their results (often called ‘flag-bits’) into dedicated destinations like status-registers, flag-registers or predication registers. Usually, there are no ‘destination’ bit-fields in the instruction format specifying flag-registers and status-registers.

In the context of the present invention, the length and the order of the bit-fields making up the format of an instruction is not relevant. In other words, it doesn't matter whether the ‘opcode’ bit-field is preceding the ‘operand’ bit-fields or vice versa nor does the order of the ‘operand’ bit-fields among each other matter. The encoding of the bit-fields is not relevant as well. Furthermore, instruction formats may be of fixed or of variable length and may contain a fixed number or a variable number of operands. In case of a variable instruction format length and a variable number of operands, additional bit-fields may be spent for these purposes. However, format length and number of operands may also be part of the ‘opcode’ bit-field. Also, an ‘operand’ bit-field is often given in form of an ‘address specifier’ bit-field and an ‘address’ bit-field. The ‘address specifier’ bit-field determines the addressing mode for the considered operand, e.g. indirect addressing, offset addressing etc. . . . , whereas the ‘address’ bit-field determines the address of the considered operand within the memory system or memory hierarchy linked or coupled to the microprocessor (see below for more details about the memory hierarchy).

It is assumed in the following that said microprocessor contains one or more functional units (FUs) such that one or more instructions may be fetched, decoded and executed in parallel. These FUs may be arithmetic logic units (ALUs), floating point units (FPUs), load/store units (LSUs), branch units (BUs) or any other functional units. From a hardware point of view, when some machine code is running on a said microprocessor it means that the instructions of said machine code are executed on the FUs of said microprocessor. As mentioned previously, data are used (read) and generated (written) by instructions in form of instruction operands and results. When an instruction is executed on a FU, it performs a number of data operations in the widest sense, e.g. any loading, storing or computing of data. If instructions generate (or compute or produce) data, then these data correspond to the results of the (data) operations performed by said instructions. These results are also called instruction results. E.g. an ‘ADD’ instruction reads two operands and generates a result equal to the sum of the two operands. Therefore, the set of data used by a machine code running on said microprocessor is part of the set of data used in form of (the values of) instruction operands of said machine code. Similarly, the data generated by a machine code running on said microprocessor is part of the set of data generated in form (of the values of) instructions results of said machine code.

In the context of the present invention, an ‘implicit’ instruction is defined to be an instruction which is known by the microprocessor prior to execution of said instruction and where said instruction has not to be specified by an ‘opcode’ bit-field or any other bit-field in an instruction format of said instruction. However, as mentioned before, an ‘implicit’ instruction may well have one or more operands and one or more destinations specified in corresponding bit-fields of said instruction format. It is also possible that an ‘implicit’ instruction may have no operands and no destination specified in any bit-field of the instruction format. In this case, the ‘implicit’ instruction may be f. ex. a special-purpose instruction which initializes some hardware circuitry of the microprocessor or has some other well defined meaning or purpose.

Always in the context of a machine code running on a said microprocessor, an ‘implicit and potential’ instruction is an ‘implicit’ instruction where the results or the outcome of instructions which have not yet finished execution decide whether:
1) said ‘implicit and potential’ instruction shall be executed or not
2) an already commenced execution of said ‘implicit and potential’ instruction is valid or not or shall be canceled or not
3) the result of a said ‘implicit and potential’ instruction which has finished execution is valid or not

In other words, the execution of an ‘implicit and potential’ instruction is delayed and is decided upon until other instructions have finished execution, although said instruction may have already entered an instruction pipeline stage like f. ex. a ‘fetch’ or ‘decode’-stage. It is important to see that ‘predicated’ instructions are special cases of ‘implicit and potential’ instructions.

Two small examples shall clarify the meaning of an ‘implicit’ instruction’ and an ‘implicit and potential’ instruction.

E.g. assume a microprocessor having an instruction format and running a machine code containing instructions out of said instruction set. Furthermore, assume that said instruction format contains two ‘operand’ bit-fields and no other bit-fields. Furthermore, assume that said microprocessor has to execute an instruction having said instruction format and that said two bit-fields specify two operands designated f. ex. by ‘op1’ and ‘op2’. In this case, an example of an ‘implicit instruction’ associated to these two operands can be any kind of instruction (or data operation) like the addition or the multiplication of these two operands or the loading of these two operands from a memory or a register file etc. . . . , and where said implicit instruction can be specified f. ex. by convention for the whole time of execution of said machine code or can be specified by another instruction which was executed prior to said instruction. An example of an ‘implicit and potential instruction’ associated to these two operands is f. ex. a load- or a move-instruction which is loading the two operands from some memory 1) only after certain instructions not yet executed have been executed and 2) only if the outcome of the results of said instructions satisfy certain conditions.

Within the scope of the present invention, it is assumed that said microprocessor has means (hardware circuitry) to measure time by using some method, otherwise machine code that is running on said microprocessor may produce wrong data or wrong results. Said terms ‘measure time’ or ‘time measurement’ have a very broad meaning and implicitly assume the definition of a time axis and of a time unit such that all points in time, time intervals, time delays or any arbitrary time events refer to said time axis. Said time axis can be defined by starting to measure the time that elapses from a certain point in time onwards, this point in time usually being the point in time when said microprocessor starts operation and begins to execute a said machine code. Said time unit, which is used to express the length of time intervals and time delays as well as the position on said time axis of points in time or any other time events, may be a physical time unit (e.g. nanosecond) or a logical time unit (e.g. the cycle of a clock used by a synchronously clocked microprocessor).

Synchronously clocked microprocessors use the cycles, the cycle times or the periods of one or more periodic clock signals to measure time. In the text that follows, a clock signal is referred to simply as a clock. However, the cycle of a said clock may change over time or during execution of a machine code on said microprocessor, e.g. the SpeedStep Technology used by Intel Corporation in the design of the Pentium IV microprocessor. Asynchronously clocked microprocessors use the travel times required by signals to go through some specific hardware circuitry as time units. In case of a synchronously clocked microprocessor, said time axis can be defined by starting to count and label the clock cycles of a said clock from a certain point in time onwards, this point in time usually being the point in time when said microprocessor starts operation and begins to execute machine code.

Therefore, if said microprocessor is able to measure time, then this means that said microprocessor is able find to out the chronological order of any two points in time or of any two time events on said time axis. In the case of a synchronously clocked microprocessor, this is done by letting said microprocessor operate with a clock in order to measure time with multiples (maybe integer or fractional) of the cycle of said clock, where one cycle of said clock can be seen as a logical time unit. Furthermore, the clock which is used to measure time is often the clock with the shortest cycle time such that said cycle is the smallest time unit (logical or physical) used by a synchronously clocked microprocessor in order to perform instruction scheduling and execution, e.g. to schedule all internal operations and actions necessary to execute a given machine code in a correct way.

However the scope of the present invention is independent of whether said microprocessor is synchronously clocked or whether it uses asynchronous clocking, asynchronous timing or any other operating method or timing method to run and execute machine code.

The so-called execution state of a machine code (often called the program counter state) running on said microprocessor usually denotes the point in time when the latest instruction was fetched, decoded or executed. If one assumes that said microprocessor operates with some synchronous clock, then another possibility consists in defining the execution state in form of an integer number which is equal to the number of clock cycles of said clock which have elapsed since said machine code has started execution on said microprocessor. Therefore, usually the execution state is incremented from clock to clock cycle as long as said machine code is running. For illustration purposes, we will assume in the following that the execution state of a machine code at a given point in time during execution of said machine code on said microprocessor is given in form of a numerical value representing a point in time on said time axis.

Whatever the clocking scheme or the operating method (synchronous or asynchronous) or the time measurement method used by said microprocessor, it is usual that instructions are pipelined. This means that:
1) said microprocessor has one or more instruction pipelines which contain each several (pipeline) stages and that instructions may take each different amounts of time (in case of a synchronously clocked microprocessor: several cycles of said clock) to go through the different stages of a said instruction pipeline before completing execution. The first pipeline stage is usually a ‘prefetch’ stage, followed by ‘decode’ and ‘dispatch’ stages, the last pipeline stage being often a ‘write back’ or an ‘execution’ stage. One often speaks of different phases through which an instruction has to go, e.g. ‘fetch’, ‘decode’, ‘dispatch’, ‘execute’, ‘write-back’ phases etc., each phase containing several pipeline stages. Therefore, the execution of an instruction may include the pipeline stages (and the amount of time) which are required to write or to store or to save operands or results into some memory location, e.g. into a register, into a cache or into main memory. In the case of a synchronously clocked microprocessor, multiples (integer or fractional) of the cycle of said clock can be used as well to specify the depth and the number of the instruction pipeline stages of said microprocessor. The number of pipeline stages that a given instruction has to go through is often called the latency of said instruction. In case of a synchronously clocked microprocessor, said latency is often given in cycle units of a clock.
   An instruction is said to be executed or to have commenced execution if said instruction has entered a certain pipeline stage, and where said pipeline stage is often the first stage of the execution phase. An instruction is said to have finished execution if it has left a certain pipeline stage, said pipeline stage being often the last stage of the execution phase. The point in time (on said time axis) at which a given instruction enters a pipeline stage is called the ‘entrance point’ of said instruction into said pipeline stage. The point in time at which a given instruction leaves a pipeline stage is called the ‘exit point’ of said instruction out of said pipeline stage.
   Usually, the operating principles of instruction pipelines are such that if an instruction enters a certain pipeline stage then said instruction triggers certain operations or events internal to the microprocessor (also called micro-operations) which are required to manipulate the data used (e.g. the operands) or generated (e.g. the results) by the instruction in a correct way. Said micro-operations are determined by the functionality of said pipeline stage and are usually part of the so-called micro-code of said instruction. Therefore, micro-code and micro-operations usually differ from pipeline stage to pipeline stage. Note that micro-code has not to be confused with machine code.
2) an instruction may enter a stage of an instruction pipeline before another instruction has left another stage of the same instruction pipeline. E.g. if an instruction pipeline has 4 stages denoted by P1, P2, P3, P4, then an instruction A1 may enter stage P2 at some point in time t1 while another instruction labeled by B1 enters stage P4 at the same point in time t1. It is also possible that the instruction pipeline of said microprocessor is such that instruction A1 may enter a stage before another instruction B1 has left the same stage.

The term instruction pipeline is still valid and keeps the same meaning even if instructions are not pipelined. In this case, an instruction pipeline has one single stage. In case of a synchronously clocked microprocessor, an instruction usually takes one cycle of a said clock to go through one stage of an instruction pipeline. Typical depths of instruction pipelines of prior-art microprocessors range between 5 to 15 stages. E.g. the Pentium IV processor of Intel Corporation has an instruction pipeline containing 20 stages such that instructions may require up to 20 clock cycles to go through the entire pipeline, whereas the Alpha 21264 processor from Compaq has only 7 stages.

In the following, the terms ‘instruction scheduling’ and ‘instruction execution’ play an important role. We give first of all a broader definition of these terms as follows:
in the context of a microprocessor executing some machine code, the terms ‘instruction scheduling’ and ‘instruction execution’ refer to the determination of the points in time of a time axis (as defined above) at which some operations or some time events are occurring (or are taking place) within said microprocessor in order to allow for a correct execution of machine code on said microprocessor

A definition of the previous terms which is closer to a physical use and implementation of an instruction format as based on the present invention and which is included in and is a special case of the previous definition, is as follows:
the terms ‘instruction scheduling’ and ‘instruction execution’ refer to the determination of the points in time on said time axis at which a given instruction of a machine code running on said microprocessor enters or leaves one or more stages of an instruction pipeline of said microprocessor in order to complete (finish) execution. In case of a synchronously clocked microprocessor, said points in time can be integer or fractional multiples of a cycle, cycle time or period of a clock.

Usually, within superscalar microprocessors, the points in time at which said instructions enter the different pipeline stages cannot be predicted and are not known prior to machine code execution. More specifically, the points in time when instructions enter the different pipeline stages depend e.a. on the following parameters:
the validness of instruction operands and results, determined by the data dependencies between instructions
on the available space within the memory hierarchy
on the access bandwidths of the memories of the memory system

Because of the non-deterministic nature of these parameters, one often speaks of dynamic instruction scheduling and execution performed internally by the microprocessor during machine code execution. It is clear that said microprocessor must have hardware means (e.g. hardware blocks like fetch, decode & dispatch units, reservation stations, memory disambiguation units etc. . . . ) in order to be able to perform dynamic instruction scheduling. Therefore, dynamic instruction scheduling has not to be confused with static instruction scheduling performed by compilers for generating machine code. Static instruction scheduling is based on deterministic algorithms like software pipelining, list or trace scheduling and pursues the goal of determining a sequential order of instructions within said machine code such that it can be executed in a correct and efficient way on said microprocessor by using dynamic instruction scheduling. Dynamic instruction scheduling analyzes the machine code generated by static instruction scheduling, and based on the above parameters determines when instructions are fetched, decoded and executed.

As mentioned before, said microprocessor is coupled to a memory system and a memory hierarchy where the data used and generated by some machine code running on said microprocessor are stored to and loaded from. Usually, the terms ‘memory system’ and ‘memory hierarchy’ are defined such as to comprise the following memories:
(1) one or more register file(s) being part of said microprocessor
(2) one or more data caches at different memory hierarchy levels, e.g. L1 and L2 data caches
(3) a main memory
(4) one or more read/write buffers of said microprocessor

When data are moved from one memory of the memory hierarchy to another one or between the microprocessor and a memory of the memory hierarchy, then they may be stored temporarily within these read/write buffers. The moving of data may be caused by instructions of a machine code being executed on said microprocessor or may performed by data caching strategies, e.g. random or least-recently used (LRU) data replacement upon data read/write-misses within data caches. Furthermore, said read/write buffers can be bypassed by the microprocessor if required and may not be visible or specifiable for the programmer or within the instruction format.

The memories of the memory hierarchy usually have different access times (latencies) for reading or writing data. The access time for reading/writing data is the time required to load/store data from/to a specific memory address respectively. The term ‘memory hierarchy level’ usually refers to an upwards or downwards sorting and labeling of the memory hierarchy levels of the memory system according to the access times for data read and data write of the different memories. E.g., if a memory A has a shorter access time for writing data than a memory B, then said memory A has either a lower or a higher hierarchy level than said memory B, depending on which sorting scheme was chosen.

Usually, if a memory A has a shorter access time for writing data than another memory, then usually memory A has also a shorter access time for reading data than the other memory.

The next concept which plays an important role in the context of the present invention is that of the lifetimes of a datum generated and used by during execution of some machine code on said microprocessor. The definition given here is a generalization of those usually found in the literature and considers also the case where a value is read by an instruction and then read again some time later by another instruction. Formally, the lifetime of a datum is defined to be a time interval on said time axis where said time interval is defined by two points in time (also called end points) as follows:
(1) the point in time when said datum is written or read by an instruction starting execution on one of the FUs of the microprocessor
(2) the point in time when said datum are written or read again by instructions starting execution on one of the FUs of the microprocessor

Clearly, the data lifetimes depend on when instructions are executed, hence on instruction scheduling. If instructions of a machine code are scheduled using static scheduling, then most of the data lifetimes can be exactly calculated before executing said machine code, by relying f. ex. on array data flow analysis. If instructions are dynamically scheduled (as is the case for most of today's microprocessors), then most of the data lifetimes are exactly known only after instructions have started executing. However, even for dynamic instruction scheduling, data lifetimes can be estimated by using a combination of array data flow analysis, branch profiling and on worst and best case static instruction scheduling (e.g. asap-schedules (as soon as possible) ) without having to execute the machine code. A precise example in section 4 shall illustrate how data life times can be either exactly calculated or estimated by using array data flow analysis and static scheduling.

Furthermore, data may be written and read into the same memory locations or memory addresses several times and this at different points in time. In this case, minimal and maximal data lifetimes are determined by the points in time where data are reused for the first and for the last time respectively. For the scope of the present invention however, it is not relevant whether the mentioned data lifetimes refer to exactly calculated or estimated lifetimes, whether minimal, maximal or somewhere between. Finally, data lifetimes are usually expressed in some time unit of said time axis. This can be in form of integer or fractional numbers. Fractional numbers usually refer to some physical time unit (e.g. in [ns]) while integer numbers are often given in cycle units of some reference clock of said microprocessor.

### 3. PRIOR ART

Two concepts play an important role in the context of the present invention:
1. autonomous load/store
2. symbolic machine code

These difference of these concepts with prior art shall now be shortly described. A more detailed description is given in section 4.

1. Autonomous Load/Store

Autonomous load/store as described by the present invention refers to the loading and storing of data which are used and/or generated by some machine code running on said microprocessor and where said data loading and storing is done without requiring explicit load/store instructions in said machine code. Autonomous load/store may be applied to the whole part of a machine code or only to portions of it. In other words, there may portions of the machine code where data loading/storing is realized by relying on explicit load/store instructions and portions where this is done by implicit load/store instructions. The scope of the present invention is independent thereof. Instead, the focus is on a method for realizing autonomous load/store, independent of whether autonomous load/store is applied to the whole part of a machine code or not.

Prior art in data loading and storing is realized by inserting explicit load/store instructions in the machine code. In other words, the execution of said explicit load/store instructions on said microprocessor performs the loading and storing of the data required by said instructions. Each explicit load/store instruction usually contains bit-fields within the instruction format specifying:
(1) a source, in other words a location or an address in the memory system which contains the value of the datum to be loaded
(2) a destination, in other words a location or an address in the memory system to which the value of the datum in question has to be stored
(3) the size of the data to be loaded or stored, where the size is often either byte (8 bit), half word (16 bit), word (32 bit) or double word (64 bit)

There exist many different variants of load/store instructions, said variants differing on how the source and destination are specified and encoded in the instruction format. These variants mainly concern address modes, in other words the ways in which the address of the source and destination are calculated. Well known address modes are f. ex. direct, indirect and modulo.

It is important to notice that the sole the purpose of a load/store instruction, whether implicit or explicit, is to perform solely the loading or storing of data to or from some memory of the memory system from or to a FU of the microprocessor.

As defined in section 2, an implicit load/store instruction also specifies the loading or storing of data, but it is not explicitly specified by a separate instruction in the machine code nor by a corresponding ‘opcode’ bit-field in the instruction format of an instruction. E.g. an instruction given in assembler notation by ADD 0x0460,R1,R3 contains implicit load/store instructions, because this instruction implicitly loads the content of address 0x0460 from some memory of the memory system and the content of register R1 from some register file, adds the contents together and implicitly (and automatically) stores the result into register R3 of some register file.

In contrast, the following small piece of machine code (in assembler notation) relies on explicit load/store instructions. It contains three consecutive instructions labeled by the machine code lines 1, 2 and 3. Instruction 1 loads a datum of size word from memory address 0x003400 (=source) into register R1 (=destination) of the register file of said microprocessor. Register R1 is subsequently used as operand by instruction 2 which adds the contents of registers R1 and R2 and stores the result into register R3. The result generated by instruction 2 (=source) is subsequently stored as a word by instruction 3 into memory address 0x003401 (=destination).
1 LDAW 0x003400,R1
2 ADD R1,R2,R3
3 STAW 0x003401,R3

Compilers generating machine code from some program written in some programming language (e.g. a program written in C++), insert explicit load/store instructions into the machine code during compilation of the program. There are many ways to do so. One possible way consists of distinguishing between scalar and indexed (array) variables declared in the source program. Scalar variables are usually register allocated, in other words the values assigned to these variables during execution of said program are kept in registers of the register file of said microprocessor, because the life times of scalar variables are usually very small. If the compiler cannot allocate all scalar variables to registers because there are not enough registers available, then the compiler must inserts explicit load/store instructions in an appropriate way in the machine code. The insertion of explicit load/store instructions for register allocated scalar variables is called register spilling and is performed according to some optimization criteria. Indexed (array) variables are often not register allocated. An indexed variable has usually several instances appearing in the source program. E.g. an indexed variable declared as c[i] with index i (0≦i≦100) in some program may appear in the program under several forms like c[3*i−1] or c[2*i+10] which are two different instances of the variable c[i]. Often, indexed variables are treated by the compiler as follows: when an instance of an indexed variable appears for the first time on the right hand side of an assignment or is used for the first time in a statement or expression of said program, then the value of that instance must be loaded from some address location of some memory of the memory system by inserting an explicit load instruction at the appropriate place in the machine code. Similarly, when an instance of an indexed variable is assigned a value by some assignment in the program, then the value in question is stored into some address location of some memory by inserting an explicit store instruction at the appropriate place in the machine code. This method shows that usually compilers do not have to perform any array data flow analysis for determining the life times of data (values of variables) in order to decide when and where to insert load/store instructions in the machine code.

Although from a historical perspective, autonomous load/store as such is not new and was already realized implicitly in the first computers built between 1945-1960, it is important to see that this was actually done because these computers were dealing with a simple single and flat memory system without any complex memory hierarchy. In this case, it was quite natural to build these early-days computers as direct memory access machines. In other words, these computers consisted more or less in one or more FUs accessing directly a single and shared memory. The consequence was that, for these machines, explicit load/store instructions were not required and therefore were absent in the machine code, because data loading and storing was done implicitly and automatically. In other words, instruction operands directly referred to values stored at specific address locations in said memory and instruction results were directly stored back to explicitly specified address locations of said memory. In that regard, these machines were also able to perform autonomous data loading and storing, because they were able to perform data loading and storing without requiring any explicit load/store instructions in the machine code. The same remark is true for ‘register file machines’, where the only memory available is a more or less simple register file. Examples of register file machines are math coprocessors built in the 80's, like the Intel 80287/80387 coprocessor, the Motorola MC68888 coprocessor, the Weitek 3364 coprocessor, the MIPS R3010 or the TI 8847 coprocessors.

However, autonomous load/store dealt with in the context of the present invention has to be realized in presence of a complex memory system and hierarchy with memories of different access times and architectures at different levels. In particular, autonomous load/store in the presence of a complex memory system and memory hierarchy requires that the microprocessor must be able at least:
1. to determine the lifetime of any instruction result during machine code execution, because the microprocessor has to know in which memory in the memory hierarchy it shall store the instruction result such that no instruction pipeline stalls or bubbles occur
2. to determine the address (memory location) in the memory hierarchy where the value of an instruction operand is stored such that said value can be loaded and transferred to the FU where said instruction shall be executed

This requires much more elaborate hardware means within the microprocessor in order to be able to do so. Furthermore, data shall be stored and loaded in such a way that instruction pipeline stalls or bubbles are avoided as much as possible, in other words in such a way that a fetched and decoded instruction has not wait for its data (the values of its operands) to become available. Therefore, data have to be stored in the right memory level of the memory hierarchy depending on the data lifetimes. The shorter the lifetime of an instruction result, the sooner it will be re-used as operand by another instruction and the faster that datum has to be accessible and loaded into a FU in order to avoid instruction pipeline stalls or bubbles. In other words, the shorter the lifetime of a datum (instruction result), the faster the memory where said datum is stored has to be accessible and vice versa. In the next section, a concrete example will show how the memory hierarchy level is determined in dependence of the lifetime of a datum.

As mentioned before, the present invention focuses on how autonomous data loading and storing is realized in the presence of a complex memory hierarchy by using the concept of symbolic machine code. The structure of symbolic machine code makes it possible for the microprocessor to determine, during execution of said symbolic machine code, the lifetimes of the data generated and re-used by instructions of said machine code. Through this, the microprocessor effectively makes itself all the information available in order to be able to determine when and where in the memory system and memory hierarchy said data have to be loaded from or stored to during the execution of said program, without requiring explicit load/store instructions in the machine code of said program. In section 4, it will be shown in detail how autonomous load/store is realized within a microprocessor which runs symbolic machine code.

2. Symbolic Machine Code

Usually, within prior art machine code, the operands and the result of an instruction refer to (or specify) one of the following:
1. a register of a register file of said microprocessor, where the content of said register is either a numeric value or an address; it the content is an address, this address specifies an address (memory location) within the memory hierarchy and this address may either hold a numeric value or still another address, and so on . . .
2. either a numeric value or an address and where said numeric value and said address are used as value for the operand or result during the execution of said instruction

Furthermore, indirect memory references in load/store instructions are often given in form of registers holding (or whose contents are) addresses and where said addresses refer to the memory locations where data have to be loaded from or stored to. E.g. ‘LD (R1)’ in assembler notation would refer to a load-instruction having an indirect memory reference in form of the memory address stored inside register R1.

Since microprocessors usually rely on register renaming during machine code execution, it usually happens that the register, where the value of an instruction operand is stored during machine code execution, is different from the register specified in the machine code for that same instruction operand. E.g. assume an instruction, being part of some machine code, which adds two numbers (values) together and is given in assembler notation like ‘ADD R1, R2, R3’ and where the instruction operands are specified by registers R1 and R2 holding the two numbers, and where register R3 specifies the location where the instruction result is stored. Then after register renaming, it may happen that, when said instruction is executed, said two numbers will be stored in registers R5 and R9 and the instruction result (the sum of the two numbers) stored in register R10. Therefore, one often speaks of symbolic registers appearing in the machine code, because register renaming dynamically re-maps (or allocates) the symbolic registers to the physical registers of the register file during machine code execution. However, first it is important to notice that a symbolic register is always re-mapped to a physical register and not to any other memory location within the memory hierarchy (the register file being part of the memory hierarchy). Second, it is important to see that register renaming does not change anything to the way in which instruction operands are specified in prior-art machine code.

In contrast to conventional machine code, in symbolic machine code, the bit-fields (within the instruction format) specifying the instruction operands and instruction results may refer to (or specify) symbolic variables. However, symbolic machine code may still contain instructions having operands and/or results specifying registers (or numeric values or addresses) as in prior-art machine code.

Java Byte Code patented by Sun Microsystems is a special case of symbolic machine code. Java Byte Code is the machine code executed by Java Virtual Machines. The instruction format of instructions in Java Byte Code allows that instruction operands and/or results may be of so-called reference type. In other words, these operands and results are pointers to objects and where said objects may be a class instance or an array. These objects may well be used to determine addresses where the values of said operands are stored. E.g. an instruction operand denoted by ‘op1’ may well be specfed by an index (e.g. a symbolic reference) into the so-called constant pool table of a method or thread currently in execution and where said index specifies a constant value. Said constant value may then be used (maybe by other instructions) in order to determine the address where the value said operand ‘op1’ is stored. However, in contrast to the present invention, the Java Virtual Machine does not exploit in any way the potential of symbolic machine code (or of Java Byte Code) in order to realize autonomous load/store. As a consequence, although Java Byte Code is already much denser than conventional (or low level) machine code, much higher density can still be achieved through autonomous load/store.

From a high level programmers' point of view, a symbolic variable may be seen as a variable or an instance of a variable, including pointer variables, as declared in some program written in some programming language (e.g. C++, Fortran, Java etc. . . . ), e.g. a integer variable declared in C++by: int my_var. From a machine code point of view, a symbolic variable often represents a dedicated cache entry or look-up-table entry holding an address (or the memory location) within the memory hierarchy of a microprocessor where the value of said symbolic variable is stored.

### 4. DESCRIPTION OF THE INVENTION AND PREFERRED EMBODIMENT

First, in order to precise the concept of symbolic machine code, the concept of symbolic variables is further defined and exemplified. As mentioned before, in symbolic machine code, the bit-fields (within the instruction format) specifying the instruction operands and instruction results may refer to (or specify) symbolic variables.

A symbolic variable is similar to a symbolic register holding an address, however with the fundamental difference that a symbolic variable does not specify a register within some register file of the microprocessor but one or more entries (or memory locations) in some dedicated memory other than the register file, and where each of said entries holds (or stores) information (or a value) which is used to determine or calculate a so-called definition address. The definition address is an address within the memory hierarchy where the value of said symbolic variable may be stored to and loaded from while allowing for a correct execution of said machine code. The value stored at said definition address is used by the microprocessor as the value for all instruction operands and instruction results specifying said symbolic variable. In its simplest implementation, the information (or the value) stored in the entry (within said dedicated memory) specified by a symbolic variable is equal to the definition address of said symbolic variable. As for any memory, said entries are (or represent) addresses or memory locations within said dedicated memory. Furthermore, said dedicated memory may be of any kind and type but is not used as register file within said microprocessor. E.g. said dedicated memory may be a data cache, a look-up-table, a main memory, a hard disk, a non-volatile memory like EPROM-, EEPROM- or MRAM-memory etc. . . . Because a symbolic variable is not a symbolic register, no re-mapping of symbolic variables is required during machine code execution, although a re-mapping may be done optionally.

In practice, a definition address may be seen as an address within the main memory as determined by the compiler during memory layout and machine code generation. The compiler tries to allocate each symbolic variable a unique definition address during machine code execution in order to avoid that valid data are overwritten, possibly resulting in an erroneous execution.

It is clear that said information, e.g. the definition addresses of said symbolic variables, which is has to be stored in the entries of said dedicated memory:
is either part of the symbolic machine code itself; in this case said microprocessor has to read in or to fetch, prior to the execution of instructions of which operands an/or results specify symbolic variables, said information from a memory (e.g. the instruction cache) where said symbolic machine code is stored and store said information into said dedicated memory
or is already stored in said dedicated memory prior to execution of said symbolic machine code

It should be noted that the above definition of a symbolic variable allows a symbolic variable to have several definition addresses.

As in the case of symbolic registers holding addresses, it is important to notice that the definition of a symbolic variable is recursive. In other words, the entry specified by a symbolic variable may hold (or store or point to) an preliminary address (or entry or memory location), this address holding yet another address which is used to determine another preliminary address and so on until the final definition address is known. E.g. if a symbolic variable specifies an 32-bit address (in hexadecimal format) 0x00000000, then this address may point to another address 0x00000020, address 0x00000020 may point to address 0x00000040 and address 0x00000040 finally holding (storing) a value of said symbolic variable. This recursion is comparable to the structure of a linked list where an element of the list points to the previous or to the next element in the list, and so on. Therefore, as will be shown shortly, symbolic variables naturally arise as the ‘machine code pendant’ of pointer variables declared in a program written in some high level programming language.

Although the difference in the definition between a symbolic register and symbolic variable may appear minor, a symbolic variable has a totally different meaning than a symbolic register and this has dramatic consequences. First, at one hand a symbolic variable is a strong generalization of a symbolic register in the way that, after definition address re-mapping, a symbolic variable may have its value stored anywhere in the memory hierarchy, and not only in some register file. Second, because in practice a symbolic variable will normally refer to a variable declared and defined in some program written in some high-level programming language (e.g. C++), it allows compilers to generate symbolic machine code from a said program in a totally new way. Third, since by definition symbolic variables make a symbolic link to memory addresses, it is possible to generate symbolic machine code which contains no explicit load/store instructions because symbolic variables contain all the information required by said microprocessor in order to determine where in the memory hierarchy it will find and store values of symbolic variables. How this is done in practice will be shown shortly.

First, a short example shall further clarify the concept of a symbolic variable. Assume that some instruction within some symbolic machine code has an instruction format where a 3-bit wide bit-field with the binary value of ‘001’ specifies an instruction operand for that instruction. Then, the binary value (number) given by ‘001’ does not refer to a specific register out of 8 possible registers of some register file nor to an address within the memory hierarchy used as operand value for that instruction, but to symbolic variable ‘001’, e.g. to a specific address out of 8 possible addresses within some dedicated cache or within the memory hierarchy, and where the content (or value) stored at this specific address is not used as operand value for that instruction, but is an address (e.g. a 32-bit address 0x00004021) holding the value (e.g. the decimal value 35) of said symbolic variable. This value is then finally used as operand value for that instruction, and where said operand is specified by the symbolic variable given in form of the binary value ‘001’.

As mentioned already in section 3, from a high level programmers' point of view, in many cases a symbolic variable corresponds to a variable or to an instance of a variable, including pointer variables, as declared in some program written in some high-level programming language (e.g. C++, Fortran, Java etc . . . ). From a machine code point of view, a symbolic variable often represents a dedicated cache entry or look-up-table entry holding the definition address (in other words the memory location) within the memory hierarchy of said microprocessor where the value of said symbolic variable is stored.

In the following, the term ‘definition address’ will simply be replaced by the term ‘address’ if no ambiguities or misinterpretations are possible.

The main aspect of the present invention is that a suitably designed microprocessor may exploit the properties of symbolic machine code in order to realize autonomous load/store. More specifically, the microprocessor may rely on some data caching strategy (e.g. random or least-recently-used (LRU) data replacement within data caches) and/or on some memory disambiguation and lifetime estimation method in order to perform a re-mapping of the definition addresses of symbolic variables. In other words, the microprocessor determines the lifetimes of symbolic variables and, depending on the lifetimes, determines where in the memory hierarchy (in a register file, in a data cache or in the main memory) the values of the symbolic variables will finally be stored. Therefore, this re-mapping does not change the definition addresses themselves, but merely where in the memory hierarchy the values, which are logically stored at said addresses, are to be stored to and loaded from during machine code execution.

These two steps are represented symbolically in FIG. 1 and form the basis for the present invention. The first step refers to the definition of symbolic variables and symbolic machine code, while the second step represents the way in which symbolic variables and symbolic machine code are used by the microprocessor in order to implement autonomous load/store. Both steps will be explained in more detail in the following.

A short example shall explain the concept of definition address re-mapping based on the lifetime of a symbolic variable. Assume that the microprocessor finds out that the definition address at which the value of a symbolic variable should be stored is equal to 0x00001000. Then, depending on the lifetime of that symbolic variable, this address may be mapped:
onto a register in some register file such that the value is finally stored that register file; as long as said value is stored there, the microprocessor knows that this value corresponds to address 0x00001000
or said address may be mapped onto a data cache such that the content of (or value stored at) said address is stored in that data cache
or said address may be mapped onto the main memory such that said value is really stored at the same physical address in the main memory

As mentioned before, the fundamental property of symbolic machine code is that it can be used to realize autonomous load/store. The example below of a C-program shall illustrate throughout the end of this section how autonomous data loading and storing is realized within said microprocessor by relying on symbolic machine code, and this in the presence of a complex memory system and memory hierarchy as defined in section 2. In particular, the example shows how symbolic machine code is looking like in practice and how the microprocessor relies on symbolic variables within symbolic machine code in order to determine when and where in the memory system and memory hierarchy said data have to be loaded from and stored to.

To this end, we consider the following C-program, where 3 integer variables i, b and c[20] are declared, and which contains a for-loop containing a conditional if-then-else statement, several assignments and expressions involving a scalar variable b and an indexed (array) variable c. The variable i represents the loop index and counts the iterations. For ease of description, the program lines are labeled upwards from 0 to 4.
0 int i, b, c[20];
1 for(i=0; i≦19; i++){
2 b=b+c[i];
3 if (b≦1) then {c[2*i]=c[i+1]; }
4 else {c[2*i]=c[i];}}

A symbolic machine code version of the above program is obtained by transforming the declared variables into symbolic variables used later in the symbolic machine code. To this end, one does first a symbolic labeling of the declared variables i, b, c[2001]. E.g. one can label variable i by v0, variable b by v1, instance c[2*] by v2, instance c[i+1] by v3, and instance c[i]by v4. These 5 consecutive labels will correspond to 5 symbolic variables in the symbolic machine code. These 5 symbolic variables can be encoded by 3 bits in 3-bit wide bit-fields for operands and results of those instructions in the C-program which use these labels as operands and/or as results. E.g., an operand bit-field of ‘000’ would correspond to variable v0, ‘001’ to variable v1, ‘010’ to variable v2, ‘011’ to variable v3, ‘100’ to variable v4.

According to the definition of a symbolic variable, when the microprocessor fetches and decodes an instruction which has f. ex. v1 specified as operand or result, then
1. the microprocessor accesses the entry ‘001’ within some memory as specified by ‘v1’
2. retrieves the address 0x00000000 stored at this entry
3. uses address 0x00000000 to load the value of said symbolic variable as operand value of said instruction.

In a straightforward approach, each symbolic variable points to an address within the memory hierarchy. In case of the scalar variables i and b, this address is equal to the definition address where their values are stored. In case of an instance of the array variable c, this (base) address is added to an offset in order to get the (definition) address where the value of that instance is stored. E.g., using C++syntax, in case of the instance c[2*i] of variable c, the offset would be equal to 2*10=20 for i=10 and the address holding the value of c[20] would be equal to definition address =base_address +offset. In case of a pointer variable *p, the symbolic variable points to the address given by p, where (e.g. according to C++ syntax of pointer arithmetic) this address is equal to the definition address and may be determined by evaluation of an arithmetic expression involving other declared variables (also pointers) and where the value *p is stored at the address given by p. Similarly for multi-level pointer variables which may be equivalently described by several simple pointer variables. E.g. in case of a declared two-level pointer *(*p) within C++, one declares instead two pointer variables *p1, *p2 of the same type and one replaces all occurrences of *(*p) by *p2and all occurrences of *p and p by *p1 and p1 respectively. In this way, the program contains only simple pointer variables which may each be referred to by a separate symbolic variable.

However, it is important to notice that the definition of symbolic variables is independent of the way in which symbolic variables are generated, labeled and encoded in the symbolic machine code. E.g. in case of the indexed variable c, one may spend a different symbolic variable for each instance of that variable (as was done above with the symbolic variables v2, v3, v4 for the instances c[2*i], c[i+1] c[i]) or just one common symbolic variable for all instances or any mixture thereof. Furthermore, in case of more complex programs, it will usually happen that additional symbolic variables, other than those declared and defined in the program, have to be spent in order to map complex expressions and statements onto the set of instructions of said microprocessor. E.g., if a C-program contains an expression involving the division of two numbers and if the microprocessor has no dedicated instruction for performing a division directly, then the division has to be realized by a set of more simple arithmetic instructions known by the microprocessor. E.g. if a Newton-Raphson scheme is used to implement a division, then this involves arithmetic instructions like addition, subtraction and multiplication. Within that scheme, each of these more simple arithmetic instructions will produce intermediate results used by subsequent instructions, until the final division result is obtained after a few iterations. Therefore, for each of these intermediate results, the compiler (or the manual writer) may have to spend an additional symbolic variable.

According to FIG. 1, the second basic step covered by the present invention consists in exploiting the properties of symbolic variables in order to generate symbolic machine code containing no explicit load/store instructions such that autonomous load/store can be realized when this machine code is running on and analyzed on-the-fly by said microprocessor. How this can be done in detail is now further explained through the following symbolic machine code corresponding to (or obtained by compiling) the above C-program.
0 ADDR v0, 0x00000000; ADDR v1, 0x00000002; ADDR v2, 0x00000008; ADDR v3, 0x00000008; ADDR v4, 0x00000008; ADDR v5, 0x00000008; ADDR v6, 0x00000008; LDC v0, #0; OFFSET v4, v0; OFFSET v2, v5 ; OFFSET v3, v6
1 ADD v1, v4, v1
2 CMP#1, v1
3 JLT#6
4 SHTL v5, #1, v0; INC v6, v1
5 TFR v2, v3; JMP#7
6 TFR v2, v4
7 BLTINC v0, #1, #20

For this version of symbolic machine code, a symbolic variable is spent for each declared scalar instance (e.g. variable i and b) and for each instance of the array variable c. Furthermore, two additional symbolic variables v5 and v6 have been spent to store intermediate instruction results of code lines 5 and 6.

The code lines are labeled upwards for illustration purposes. Instructions in the same code line are separated by semicolons (;). Instruction arguments are separated by colons (,). Constant arguments are marked with a ‘#’ - sign followed by the decimal value of the constant. The mnemonics for each instruction are given in uppercase letters.

First, in line 0, a definition address is defined for each symbolic variable referring to a declared scalar variable in the C-program and a base address is defined for each instance of the declared array variable c. E.g. the instruction ADDR v0, 0x00000000 assigns the 32bit hexadecimal address 0x00000000 as definition address to the symbolic variable v0. In other words when the microprocessor fetches and decodes an instruction which has v0 as operand or result, then
4. the microprocessor accesses some entry (address) within some memory as specified by ‘v0’, e.g. entry 001 out of 8 possible entries
5. retrieves the address 0x00000000 stored at this entry
6. uses address 0x00000000 to load the value of said symbolic variable as operand value of said instruction

Furthermore, line 0 determines the offsets (e.g. v0, v5, v6) which have to be added to the base addresses of the symbolic variables (e.g. v4, v2, v3) referring to the instances of the array variable c in order to get the definition addresses where the values of said instances are stored. E.g. OFFSET v4, v0 adds the offset given by the value of symbolic variable v0 to the base address of symbolic variable v4.

Line 1 corresponds to line 2 of the C-program. Line 2 corresponds to the comparison ‘b<=1’ in line 3 of the C-program. Line 4 computes the offsets of symbolic variables v2, v3 in form of the symbolic variables v5 and v6. Lines 5 and 6 perform the assignments of line 3 and 4 of the C-program. Line 7 increments the iteration counter (symbolic variable v0) and branches back to code line 1 in order to execute the next iteration.

Assume that said microprocessor uses said symbolic machine code in order to realize autonomous load/store of data to and from a memory system and memory hierarchy comprising the following memories and memory hierarchy levels:
1. the register file(s) of the microprocessor itself
2. a data cache at memory hierarchy level 1, e.g. a L1 data cache
3. the main memory

Furthermore, assume that said microprocessor is synchronously clocked with some reference clock and that the read/write times (e.g. the access times for reading data and writing data) are equal to:
1. 1 clock cycle in the case of the register file
2. 10 clock cycles in the case of the L1 data cache
3. 50 clock cycles in the case of the main memory

The considerations that follow can be extended to the case where the read times are different from the write times.

Since the above C-program contains only scalar and array variables, it is possible to use array data flow analysis in order to determine the data life times of all declared variables and instances before running the machine code. Therefore, before describing how the microprocessor relies on a dynamic method to determine the lifetimes during machine code execution, array data flow analysis is useful in order to explain how the data are stored in the memory hierarchy in dependence of their lifetimes.

The procedure that is used in order to perform a re-mapping of the definition address of a symbolic variable, e.g. in order to determine the memory hierarchy level in dependence of the lifetime of a value of said symbolic variable, is as follows:
the memory hierarchy levels of all the memories of the memory system are determined by the sorting and labeling procedure as explained in section 2, where all the memories of the memory system are sorted and labeled upwards according to their access times for reading data and writing data
let M denote the number of memory hierarchy levels of the memory system; for all j: 0≦j≦M−1: let tⱼ denote the sum of the access times for data read and data write of a memory of memory hierarchy level j; by definition t_{M}=∝ (infinite); if the lifetime λ of said value satisfies for some k: tₖ≦λ<tₖ₊₁, then said value is stored into a memory of memory hierarchy level j

However, before applying array data flow analysis, further assumptions have to been made about how the above machine code is executed on said microprocessor. First, for simplicity it is assumed that each instruction (of the machine code) has an execution latency of one clock cycle. Second, branch prediction is assumed to be perfect. In other words, the branch of line 3 within the above machine code is always correctly predicted such no instruction pipeline stalls or bubbles occur. Third, the machine code is arranged in such a way that instructions within the same code line can be executed in parallel and instructions in subsequent code lines executed sequentially. This implies a sequential execution of the iterations of the for-loop. The following considerations can be extended to the case where the iterations of the for-loop are executed in parallel or in an overlapping fashion as done f. ex. in software-pipelining. However, a sequential execution allows for a better understanding of the concepts involved.

According to the definition of data lifetimes, one has to determine when the value of a symbolic variable is written or read by an instruction (e.g. is specified by an instruction operand or result) and to determine the number of clock cycles until that value is used again by another instruction, but maybe specified by another symbolic variable. The data life times are determined by adding up the clock cycles separating the execution time of both instructions. For the scalar variables v0, v1, v5 and v6, determining the life times is very easy because they do not depend on the iteration count. However, for the array variable c as declared in the C-program above, different instances of that variable may hold the same value, depending on the iteration. In other words, one has to find out for which iterations which of the symbolic variables v2, v3, and v4 hold the same value. This is exactly the purpose of array data flow analysis, a task which is also called memory disambiguation. Furthermore, since there are two possible traces within each iteration, depending on which branch is taken by the Jump instruction ‘JLT#6’ in machine code line 3, the data lifetimes depend on that branch as well.

First, it is shown how the data lifetimes of symbolic variables v0, v1, v5 and v6 referring to declared scalar variables are determined. To this end, we consider variable v0 which is first read and then written (or specified as instruction result) in code line 7, then read (or specified as instruction operand) again in code line 4. Therefore the lifetime of the value of symbolic variable v0 is equal to:
1. 5 clock cycles when the jump in code line 3 is taken
2. 6 clock cycles the jump in code line 3 is not taken

Since in any case, the life time is less than 6 clock cycles, all values taken by the symbolic variable v0 during machine code execution have to be stored in the register file if the values shall be accessible without causing pipeline stalls or bubbles. If one would store the values in the L1-cache or main memory, then pipeline stalls or bubbles would be inevitable because the values could not be stored and then loaded again in time because the access times for reading/writing data to/from the L1-cache and main memory are larger than the data lifetimes.

The lifetime of the value of symbolic variable v1 is determined in the same way and is equal to either 1 and 4 or 1, 2 and 3 clock cycles if the jump in code line 3 is taken or not respectively. The lifetimes of the values of symbolic variables v5, v6 are equal to 1 clock cycle since they are used as offset by the ‘OFFSET’ instructions in code line 0 as soon as they are computed.

In order to find out the lifetimes of the instances v2, v3, and v4 of array variable c as declared in the C-program, one has first to solve the diophantine equations c[i]=c[i], c[i]=c[i+1], c[i+1]=c[2*i] and c[i]=c[2*i] in i and i′ and write the solutions in the form of i′−i = . . . . The left hand side of these equations involves instances which are read only while the right hand side involves instances which are read or written. The solution for the mentioned equations are as follows (in their order listed above):
i′−i=0, meaning that the value of instance c[i] is read again in the same iteration and in the same form
i′−i=1, meaning that the value of instance c[i+1] is read again one iteration later in form of the value of symbolic variable c[i]
i′−i=i−1, meaning that the value of instance c[2*i] is read again i−1 iterations later in form of the value of symbolic variable c[i+1]
i′−i=i, meaning that the value of instance c[2*i] is read again i iterations later in form of the value of symbolic variable c[i]

Since an iteration takes either 5 or 6 clock cycles to execute, depending on whether the branch in code line 3 is taken or not, the solution of the above equations gives the following data lifetimes:
3 clock cycles for the value of instance c[i] if the branch in code line 3 is taken
either 5 or 6 clock cydes for the value of instance c[i+1] on whether the branch in line 3 is taken or not
for i>=2: either 5*(i−1) or 6*(i−1) clock cycles for the value of instance c[2*i] depending on whether the branch in line 3 is taken or not

This leads finally to the lifetimes of the symbolic variables v2, v3 and v4 as summarized in table 1.

As before in the case for the symbolic variables v0, v1, v5 and v6, the values of the symbolic variables v2, v3 and v4 must be stored in the memory system and memory hierarchy as follows, if we want to avoid instruction pipeline stalls or pipeline bubbles:
the value of instance c[i] always in the register file
the value of instance c[i+1] always in the register file
the value of instance c[2*i]:
   a. for iteration i=2: in the register file
   b. for iterations 2<i<11: in the L1 data cache if the jump in code line 3 is taken
   c. for iterations 2<i<10: in the L1 data cache if the jump in code line 3 is not taken
   d. for iterations 10<i: in the main memory if the jump in code line 3 is taken

e. for iterations 9<i: in the main memory if the jump in code line 3 is not taken

TABLE 1
Lifetimes of the values of the symbolic variables v0, v1, v2, v3, v4, v5, v6

| | v0 | v1 | v2 | v3 | v4 | v5 | v6 |
|---|---|---|---|---|---|---|---|
| Jump taken | 5 | 1, 4 | 3 | 5 | 5*(i − 1) for i >= 2 | 1 | 1 |
| Jump not taken | 6 | 1, 2, 3 | n. | 6 | 6*(i − 1) for 1 >= 2 | 1 | 1 |
| | | | def. | | | | |

As mentioned before, the microprocessor uses a different method in order to perform dynamic memory disambiguation and data lifetime estimation during execution of the machine code. The basic principle of this method consists on computing the (definition) addresses where the values of instruction operands and results specifying symbolic variables are stored to or loaded from:
if any two operands of any two different instructions i1 and i2 of the machine code have their values stored at the same address (memory location) within the memory hierarchy and if instruction i1 is executed before instruction i2, then the lifetime of the value of the operand of instruction i1 is equal to the amount of time (in clock cycles) separating the points in time when both instructions begin execution, e.g. if instruction i1 begins execution at time t=0 and instruction i2 begins execution at time t=5, then the operand lifetime is equal to 5 clock cycles
if the result of any instruction i1 and the operand of any other instruction i2 have their values stored or to be stored at the same address and if instruction i1 is executed before instruction i2, then the lifetime of the value of the result of instruction i1 is equal to the amount of time (in clock cycles) separating the points in time at which instruction i1 ends execution and instruction i2 begins execution, e.g. if instruction i1 ends execution at time t=0 and instruction i2 begins execution at time t=5, then the operand lifetime is equal to 5 clock cycles

This shows that, if the microprocessor relies on this principle, it cannot know the data lifetimes exactly before instructions begin and/or finish their execution. Furthermore, since many microprocessors use dynamic instruction scheduling and execution, the points in time at which instructions begin their execution depend also on the data dependencies between instructions which are often not known in advance. However, since data have to be stored somewhere in the memory hierarchy before they are used by instructions which begin execution, the microprocessor is forced to estimate the lifetimes in some way.

One possible way consists in setting the lifetime equal to the amount of time separating the fetching of instructions, instead of the starting points and end points of their execution as was explained before. In other words, if any two operands of any two different instructions i1 and i2 of the machine code have their values stored at the same address (memory location) within the memory hierarchy and if instruction i1 is executed before instruction i2, then the lifetime of the value of the operand of instruction i1 is estimated to be equal to the amount of time (in clock cycles) separating the points in time when both instructions are fetched. Analogously for the case of the lifetime of an instruction result reused as operand of another instruction at later point in time.

However, using the point in time when instructions are fetched as reference point to measure lifetimes further limits the time window within which lifetimes can be measured or estimated. To see why, assume that the microprocessor stores all instructions, which have been fetched so far but not yet executed, in a fetch buffer or instruction queue. Since the microprocessor can only estimate the lifetimes of operands and results of instructions already fetched into the fetch buffer, then if the microprocessor is able to fetch instructions up to M (M being a positive integer) clock cycles before they begin execution the only statement the microprocessor can make out about the lifetime of an instruction operand or result is that:
either the lifetime is within the range of or smaller than M clock cycles
or the lifetime is outside or larger than that range

However, by using the fetch order of instructions stored in the fetch buffer and by analyzing their data dependencies and execution latencies, it is possible to make more accurate estimations of those lifetimes which fall within the range of M clock cycles. A concrete example hereof is discussed below.

Instead of using the points in time when instructions are fetched, one can also use other pipeline stages as reference points to measure or estimate data lifetimes or any other method. The dynamic method used by the microprocessor in order to estimate data lifetimes during machine code execution is described hereafter in form of a preferred embodiment is independent thereof.

Before describing this method in detail, additional features and capabilities, which said microprocessor may have in order to exploit instruction level parallelism in different forms and by different methods, are discussed in order to show the general scope of the present invention. In other words, said microprocessor may have less or even further capabilities for exploiting instruction level parallelism, this without impeding the scope of the present invention.

First, said microprocessor may have means to do predictions of the following kinds:
1. branch address prediction, in order to predict whether a jump or branch is taken or not, and where said prediction is known to the microprocessor a certain amount of time (given in clock cycles) before the actual jump or branch instruction is executed; in other words, when a branch or jump instruction is fetched and decoded, the microprocessor is able to predict whether that jump will be taken or not; the microprocessor may then continue to fetch, decode and execute instructions from the predicted branch or jump address onwards; instructions fetched from a predicted branch may be marked as ‘speculative’
2. value prediction of instruction operands/results, in order to overcome the data flow limit given by the data dependencies between instructions; predicted instruction operands and results may be marked as ‘speculative’
3. load/store address predictions in order to speculatively execute explicit load/store instructions; predicted load/store addresses may be marked as ‘speculative’
4. address prediction of symbolic variables in order to speculatively load/store the values of symbolic variables; predicted addresses may be marked as ‘speculative’.

Second, the microprocessor may have means to find out if and when the operands and results of any instruction are valid or become valid. An operand and result of an instruction is valid if and only if:
1. the address (within the memory hierarchy) at which the value of said operand or result shall be stored or loaded from, is not marked as ‘speculative’
2. and the value of said operand or result is not marked as ‘speculative’, in other words after all data dependencies (RAW hazards) and all name dependencies (WAR, WAW hazards) with operands and/or results of other instructions are respected

If one of more of these two conditions are not satisfied and/or if the instruction itself is marked as ‘speculative’, the microprocessor may then speculatively execute said instruction and mark the result of said instruction as ‘speculative’. In other words, whatever the address (or memory location) where said result is stored or has to be stored in the memory hierarchy, said address has a tag which tells the microprocessor that said value is ‘speculative’ whenever the microprocessor accesses said address again.

Third, if a prediction of one or more of the previous kinds turns out to be false, the microprocessor may have means to flush only those instructions in the instruction pipeline and to re-execute only those instructions which are marked as ‘speculative’. Furthermore, any memory locations within the memory hierarchy holding data (or values) marked as ‘speculative’ may become free or available for overwriting.

The dynamic method used by the microprocessor in order to perform dynamic memory disambiguation and data lifetime estimation comprises the following basic steps:
1. when the microprocessor fetches an instruction which has one or more symbolic variables specified as an operand and/or result, it uses the information stored in the entries specified by said symbolic variables in order to compute or determine the addresses (memory locations) within the memory hierarchy where the values of said symbolic variables are (to be) stored; in this way, each of said computed addresses refers to a value of a said symbolic variable; in other words, the value (to be) referred to by said computed address is the value of an instruction operand or of an instruction result specifying said symbolic variable;
2. after anyone of said addresses has been computed (or determined), the microprocessor writes this computed address into an entry of a dedicated memory; the exact point in time at which said computed address is written is not relevant for the scope of the present invention; said dedicated memory will also be called ‘heap address cache’ in the following;
3. in addition to said computed address, said microprocessor writes data associated to said computed address into said heap address cache and/or into another memory; said data are also called ‘link data’ in the following; said data are such that, when they are accessed by the microprocessor, they allow the microprocessor to make the link with (or to associate them to) said computed address and to determine whether said computed address refers to the value of an operand and/or of a result of said instruction; the order in which said computed address and its link data are written is not relevant for the scope of the present invention; usually however the link data are written before the address is computed;
4. the microprocessor may use said entry of the heap address cache in order to determine/estimate:
   the lifetime of the value to be stored or loaded from said computed address
   and/or the amount of time which elapsed since a previous write of the same address into an entry of said heap address cache; in other words said same address is identical to said computed address, but refers may be to the value of a different symbolic variable and has been computed and written chronologically before said computed address;

In other words, when the microprocessor knows two entries where said computed address has been written, then it is able to determine the amount of time which elapsed between the first and second write of said computed address into said heap address cache; said previous write may be any write which occurred chronologically before the write of said computed address in step 2.; for practical purposes however, said previous write most often refers to the last write, e.g. the last write which occurred before the write of said computed address in step 2.
5. the microprocessor may use said link data in order to determine/estimate the lifetime of said value and/or the amount of time which elapsed since a previous write of the same address into an entry of said heap address cache;
6. the microprocessor uses the lifetime of said value in order to determine the memory location (address) and/or the hierarchy level within the memory hierarchy where said value shall be stored; an example of a concrete procedure used by the microprocessor in order to determine the memory hierarchy level in dependence of the lifetime of a datum was given above

Additional steps may be required in order to:
mark an entry in the heap-address cache as ‘speculative’ if the value of the instruction operand and/or result or the instruction itself is marked a ‘speculative’
mark an entry in the heap-address cache, which was so far marked as ‘speculative’, as ‘invalid’ when the corresponding prediction turns out to be false

In step 1., the computation of the definition addresses of symbolic variables, e.g. the computation of address offsets of symbolic variables referring to instances of array variables (see above for concrete examples), may require the execution of a more or less large portion of machine code containing several instructions. This means that said addresses are finally given (or computed) in form of instruction results which yield the addresses of said symbolic variables. However, this means that in general these instruction results hold definition addresses which refer to other symbolic variables than those specified by the instruction results themselves. In other words, a definition address being the value of a symbolic variable specified by an instruction result may not be the definition address of that same symbolic variable, but of another one. E.g. assume that the value of a symbolic variable (denoted by) v1 is a (32-bit) definition address 0x04003020. This definition address may well be the definition address of another symbolic variable v2. Therefore, it is useful to define instructions in the instruction set of said microprocessor which make the link between symbolic variables and their definition addresses. These instructions, which make a link between definition addresses and symbolic variables, are called symbolic link instructions in the following.

An short example shall clarify the concept of symbolic link instructions. E.g., assume that we want to compute the definition address of a symbolic variable s1 and that, after execution of some instructions, the result of the last executed instruction yields the definition address of symbolic variable s1 and specifies another symbolic variable s2. Then a symbolic link instruction specifies these two variables s1 and s2 as its operands and makes a symbolic link between them. After decoding and executing such an instruction, the microprocessor knows that:
the value of symbolic variable s2 is used in the further computation of the definition address of symbolic variable s1 or
that the value of symbolic variable s2 is equal to the definition address of symbolic variable s1

An example of symbolic link instruction is the ‘OFFSET’ instruction used in the above symbolic machine code.

A symbolic link instruction may also:
be given in form of an implicit instruction having one or more operands
and maybe part of a more complex (and maybe implicit) instruction; in other words, the execution of said complex instruction performs, among other data operations, the same data operations as the symbolic link instruction taken alone.

Typically, a symbolic link instruction may be part of an instruction which, among other data operations, assigns definition addresses to symbolic variables. E.g. a symbolic instruction could be part an ‘ADDR 0x00006700, v0, v1’ instruction, which:
assigns definition address 0x00006700 to symbolic variable v0
makes the link between symbolic variables v0 and v1, and indicates to the microprocessor that the value of symbolic variable v0 is used in the computation of or is equal to the definition address of v1

As mentioned above, these link instructions may have to be fetched by the microprocessor prior to execution of instructions having operands specifying symbolic variables.

The above method also includes the case where several instructions are fetched and decoded in parallel in one clock cycle such that several addresses, each holding a value of a specific symbolic variable, are determined at the same time and have to be written at the same time into the heap-address cache. However, it is not relevant whether they are written into the same or into different entries of the heap-address cache.

The basic steps 1. to 6. of the above method shall now be described in more detail by a preferred embodiment.

In one preferred embodiment, the heap-address cache is realized in form of a circular stack. In a circular stack, the stack pointer wraps around the top of the stack back to the bottom (or the first written) address or entry when reaching the top of the stack. E.g. assume a circular stack with 128 entries labeled 0 to 127. When the stack pointer points to entry 127 and a further write occurs, then the stack pointer wraps around and points to entry 0. As usual, the stack pointer either points to the last written or to the next free (or higher) entry. The stack pointer may only be incremented when the last written entry contains valid data only. Or the stack pointer may be incremented with each clock cycle of the microprocessor. Furthermore, in a circular stack data may be written anywhere in the stack, not only into the entry pointed to by the stack pointer. Furthermore, in a circular stack the order in which stack entries are read may be arbitrary and may be different from the order in which they were written to the stack. This means that when a stack entry is read, only the data stored in those stack entries above that entry are popped down (or shifted down as in a shift register) by one position and the stack pointer decremented. In case that the stack pointer wraps around, the pop down (or shift down) process also wraps around. E.g. assume a above circular stack with 128 entries. If the stack pointer has wrapped around and points to entry 3 and if entry 126 is read, then the data stored in entry 127 are shifted into entry 126, those of entry 1 into entry 127, those of entry 2 into entry 1 and those of entry 3 into entry 2.

However, the pop down (or shift down) process which occurs upon a stack read is not very energy efficient because it consumes a lot of electrical power.

Therefore, in another variant of a circular stack, the shift down process is not implemented and is never executed when a stack read occurs. Instead, when data are written into a stack entry, the data are marked as such, e.g. as ‘valid’, and when data are read from a stack entry, the data are marked as such, e.g. as ‘invalid’. In this case, when the stack pointer has wrapped around and points to an entry which contains still valid data, there are three options:
either the microprocessor stops fetching and decoding further instructions until that stack entry becomes free or available
or it overwrites the data in that entry
or the stack pointer is incremented until it points to an entry containing no or invalid data

Similarly, when all stack entries contain valid data and no further stack entries are free or available for writing, either the microprocessor stops fetching and decoding further instructions until stack entries become free or available or it continues to overwrite valid data in stack entries. Whatever option is finally implemented, the method described herein is independent thereof. Furthermore, this method assumes that all entries of the circular stack contain only invalid data when the microprocessor starts running said machine code.

When such a circular stack is used as heap-address cache, the steps 2. and 4. are slightly modified as follows:
2. after anyone of said addresses has been computed, the microprocessor writes this computed address into the same entry as the one where the link data in step 4. are written; if said computed address is written before the link data are written, then said computed address is written into the entry pointed to by the stack pointer; the exact point in time at which said computed address is written is not relevant for the scope of the present invention;
3. said link data are written into the same entry of the circular stack as said computed address and comprise:
   a ‘type’-flag, which tells the microprocessor whether the said computed address refers to the value of an instruction operand or of an instruction result, e.g. whether the value (to be) stored at said computed address is the value of an instruction operand or of an instruction result
   a ‘valid’-flag, which tells the microprocessor whether the entry contains data which can be overwritten or not;
   if anyone of said two flags are written before said computed address is written, then said flag is written into the entry pointed to by the stack pointer;

Steps 1., 4., 5. and 6. remain unchanged. Notice that the names given to the mentioned flags are not relevant and do not affect the scope of the present invention. Furthermore, the mentioned link data represent an minimal set of link data which are necessary for a correct working of the method. However, additional link data may be written into each entry of the circular stack, e.g.:
the label of the symbolic variable of which the value shall be stored at said computed address
an execution state value, which allows to determine the execution state of said machine code at the point in time when said instruction is fetched or when said link data are written

A small example shall illustrate how the microprocessor uses the information stored inside the entries of the circular stack in order to determine data lifetimes. To this end, we assume a circular stack with 128 entries as described above and we refer to the above machine code and assume that the microprocessor begins fetching and decoding instructions lying along the branch predicted to be taken according to branch prediction. E.g. assume that the jump instruction in line 3 is predicted to be always taken for the next 4 iterations i=0, 1, 2, 3. Then the instructions are fetched and decoded in the same order as the code lines 1, 2, 3, 6, 7 on that predicted path. Two slightly different variants of a circular stack are now used in order to estimate data lifetimes. In a first variant, the stack pointer is incremented with each clock cyde of the microprocessor clock while in the second variant the stack pointer is only incremented after a write to an entry which contains invalid data only.

For the first variant, assume that at some point in time an instruction is fetched and that the value of one of its operands has been determined to be equal to 0x00000008 and then written into entry 12 of the circular stack and the type-flag and valid-flag set accordingly. Assume that, 5 clock cycles later, another instruction is fetched and that the value of one its operands has the same address as before and is written into entry 17 (=12+5) because the stack pointer has been incremented in the mean time by 5. Then the microprocessor scans all the entries of the circular stack until if finds out that entry 17 contains the same address than entry 12. Then, based on the flags being set appropriately in both entries, the microprocessor estimates the lifetime of the value stored in entry 12 of the circular stack and having an address 0x00000008 as being equal to 17−12=5 clock cycles. Therefore, in this case the lifetime is determined by subtracting the entry (e.g. 17) containing address 0x00000008 from another entry (e.g. 12) containing the same address.

For the second variant, assume that the same two instructions are fetched 5 clock cycles apart. Since now the stack pointer is not incremented with each clock cycle, additional link data must be written into each entry of the circular stack such that the microprocessor knows how much time has elapsed between the fetches of both instructions. This can be done by writing an execution state value into each entry of the circular stack, which allows the microprocessor to reconstruct the points in time when said instructions were fetched. In a straightforward approach, this execution state value would be equal to the clock cycle when said instruction was fetched. E.g. assume that we label the clock cycles from zero upwards, beginning with the point in time when the microprocessor begins fetching and executing instructions form said machine code. If said first instruction was fetched at clock cycle 5 and the address 0x0000008 written in entry 2 of the circular stack and said second instruction was fetched at clock cycle 10 and written in entry 4 (because in the meantime three other writes to the circular stack had occurred incremented the stack pointer by 2), then the clock cycle values of 5 and 10 would be written into entries 2 and 4 of the circular stack respectively. Then, as for the first variant, the microprocessor scans all the entries of the circular stack until if finds out that entry 4 contains the same address than entry 2. Then, based on the flags being set appropriately in both entries and by using the clock cycle values stored in each entry, the microprocessor estimates the lifetime of the value stored in entry 2 of the circular stack and having an address 0x0000008 as being equal to 10−5=5 clock cycles. Therefore, in this case the lifetime is determined by subtracting the execution value stored in the entry (e.g. 4) containing address 0x0000008 from the ex3cution state value stored in another entry (e.g. 2) containing the same address 0x00000008.

Last, the microprocessor has to rely on a concrete procedure to determine the memory hierarchy levels where the value of said symbolic variables have to be stored in dependence of the lifetimes of said values. If one takes the same procedure for (definition) address-re-mapping as used above, then the value of the symbolic variable having (definition) address 0x00000008 would be stored in the register file, because the access time of the register file is shorter than the lifetime of said value and the access time of the L1 data cache being larger. If, at some later point in time (e.g. after 100 clock cycles) another instruction is fetched whose operand has its value stored at the same address 0x00000008, but where this time said address holds a value whose lifetime is estimated to be equal to 30 clock cycles, then the same address would mapped onto the L1 data cache and its value stored there, because the access time of the L1 data cache being shorter than the lifetime of said value and the access time of the main memory being larger.

5. SUMMARY OF THE INVENTION

The present invention concerns a method for implementing autonomous load/store of data within the memory hierarchy coupled to a microprocessor by using symbolic machine code.

1. a method for implementing autonomous load/store within a data processing system by using symbolic machine code,
where said data processing system comprises a microprocessor and a memory system,
where said memory system has a memory hierarchy containing:
one or more register files of said microprocessor
one or more data caches at different memory hierarchy levels
a main memory
where said microprocessor has an instruction set and where said instruction set contains one or more instructions of which one or more operands and/or results may specify one or more symbolic variables,
where a symbolic machine code is running on said microprocessor,
where said symbolic machine code contains one or more instructions of which one or more operands and/or results specify one or more symbolic variables,
where said autonomous load/store refers to the loading and storing of data generated and used by said symbolic machine code and where at least part of said data loading and storing is done without requiring any explicit load/store instructions in said symbolic machine code,
where each of said symbolic variables specifies one or more entries of a memory other than a register file of said microprocessor,
where said entries are used by the microprocessor in order to determine the addresses within the memory hierarchy where the values of said symbolic variables may be stored to and/or loaded from during execution of said symbolic machine code,
where said method comprises the following steps:
a. when the microprocessor fetches an instruction of which a result and/or one or more operands specify one or more symbolic variables, it computes the addresses within the memory hierarchy where the values of said symbolic variables may be stored into and/or loaded from;
b. after anyone of said addresses has been computed, the microprocessor writes this computed address into an entry of a dedicated memory; in the following, said dedicated memory is referred to by the term heap address cache;
c. in addition to said computed address of step b., said microprocessor writes data associated to said computed address into said heap address cache and/or into another memory; said data are also called link data in the following; said link data are such that, when they are accessed by the microprocessor, they allow the microprocessor to make the link with or to associate them to said computed address and may be used to determine whether said computed address refers to the value of an operand and/or of a result of said instruction
d. the microprocessor uses said entry within said heap address cache in order to determine or estimate:
i. the lifetime of the value to be stored to or to be loaded from said computed address
ii. and/or the amount of time which elapsed since a previous write of the same address into an entry of said heap address cache;

2. a method as claimed in claim 1,
where step d. is further specified as follows:
the microprocessor uses said entry within said heap address cache and/or said link data in order to determine or estimate the lifetime of said value by determining or estimating the amount of time which elapsed since a previous write of the same address into an entry of said heap address cache;

3. a method as claimed in claim 2,
where said heap address cache is realized as a circular stack,
where steps b. and c. are further specified as follows:
b. after anyone of said addresses has been computed, the microprocessor writes this computed address into the same entry of the circular stack as the one where the link data in step d. are written;
c. said microprocessor writes said link data into the same entry of the circular stack as said computed address, said link data comprising one or both of the following:
a type-flag, which tells the microprocessor whether the value stored or to be stored at said computed address refers to the value of an instruction operand or of an instruction result
a valid-flag, which tells the microprocessor whether the entry contains data which can be overwritten or not

4. a method as claimed in claim 3,
where, in addition to the data mentioned in step c., said link data further contain an execution state value, this value allowing to determine the execution state of said symbolic machine code at the point in time when said instruction is fetched or when said link data are written

5. a method as claimed in claim 3,
where step b. is further specified as follows:
the microprocessor uses said entry within said heap address cache and/or said link data in order to determine or estimate the lifetime of said value by subtracting the entry containing said computed address from another entry of said heap address cache containing the same address;

6. a method as claimed in claim 4,
where step b. is further specified as follows:
the microprocessor uses said entry within said heap address cache and said execution state value in order to determine or estimate the lifetime of said value by subtracting the execution state value stored in the entry containing said computed address from the execution state value stored in the same or in another entry of said heap address cache containing the same address;

7. a method as claimed in claim 1,
where the microprocessor uses the lifetimes of the values of said symbolic variables in order to determine the addresses and/or the hierarchy levels within the memory hierarchy where said values shall be stored;

8. a method as claimed in claim 2,
where the microprocessor uses the lifetimes of the values of said symbolic variables in order to determine the addresses and/or the hierarchy levels within the memory hierarchy where said values shall be stored;

9. a method as claimed in claim 3,
where the microprocessor uses the lifetimes of the values of said symbolic variables in order to determine the addresses and/or the hierarchy levels within the memory hierarchy where said values shall be stored;

10. a method as claimed in claim 4,
where the microprocessor uses the lifetimes of the values of said symbolic variables in order to determine the addresses and/or the hierarchy levels within the memory hierarchy where said values shall be stored;

11. a method as claimed in claim 5,
where the microprocessor uses the lifetimes of the values of said symbolic variables in order to determine the addresses and/or the hierarchy levels within the memory hierarchy where said values shall be stored;

12. a method as claimed in claim 6,
where the microprocessor uses the lifetimes of the values of said symbolic variables in order to determine the addresses and/or the hierarchy levels within the memory hierarchy where said values shall be stored;

13. A microprocessor having an instruction set containing:
one or more instructions of which one or more operands and/or results may specify one or more symbolic variables
one or more symbolic link instructions
where said microprocessor is able to execute symbolic machine code,
where said symbolic machine code contains one or more instructions of which one or more operands and/or results specify one or more symbolic variables
